(19) United States
(12) Patent Application Publication
(10) Pub. No.: US 2006/0243721 A1
(43) Pub. Date: Nov. 2, 2006

(54) Conveyor steam cabinet and preparation method for consumable-at-sale food products

(76) Inventors: Chris Sorensen, Jacksonville, FL (US); Robin Sorensen, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/403,531

(22) Filed: Apr. 13, 2006

Related U.S. Application Data
(60) Provisional application No. 60/671,418, filed on Apr. 14, 2005.

(51) Int. Cl. F27D 11/00

(52) U.S. Cl. 219/401

(57) ABSTRACT

A steam cabinet having conveyor means to move food product though a steam chamber for moist heating. Steam may be provided for example by a boiler system or by applying water to a heated surface within the steam chamber of the steam cabinet. The apparatus enables a fast food sandwich restaurant to prepare a sandwich by toasting a bun or roll on a conveyor toasting apparatus and simultaneously steam heating the meat and cheese on the steam heating apparatus, such that the meat and cheese can be placed into the hot toasted bun immediately upon discharge from the steam heating apparatus. The steam chamber is bounded on either side by venting chambers, such that any steam escaping fro the steam chamber is exhausted to the exterior of the building.

This application claims the benefit of U.S. Provisional Patent Application Ser. No. 60/671,418, filed Apr. 14, 2005, the disclosure of which is incorporated herein by reference.

### BACKGROUND OF THE INVENTION

This invention relates generally to the field of apparatuses and methods used to apply steam to an item for handling, processing or preparation purposes, and more particularly to such apparatuses and methods used in the handling, processing or preparing of food products that are able to be consumed immediately upon purchase. Even more particularly, the invention relates to such apparatuses and methods that are used to raise the temperature of food products to a desired temperature using moist heat in the form of steam, wherein the food products are sandwiches having a toasted bun and steam heated fillers of meat and/or cheese.

In the food industry it is often necessary or desirable to heat food products to a predetermined temperature, and various methodologies are available to accomplish this. Raising the temperature of certain food products, in particular sandwiches containing meat and/or cheese, during preparation for immediate consumption using moist heat in the form of steam has been found to be both efficient and beneficial in improving desirable taste qualities. For example, steam heating several slices of meat and cheese to a temperature of about 140 degrees F. prior to placement into a toasted bun has proven to be very successful in the fast food sandwich marketplace based on customer satisfaction.

The methodology currently in use comprises places a serving of meat and cheese slices into a small steam cabinet capable of holding only one or two servings at a time. A heated metal plate is disposed in the cabinet. A perforated basket suspended above the plate receives the food serving, and a lid is provided to close the cabinet. Water is pumped or sprayed onto the metal plate to produce steam. The steam rises through the perforations to heat the meat and cheese.

While this method is successful in producing the desirable food product for consumption, there are several drawbacks and problems associated with this batch method of heating food products. Each steam cabinet has limited capacity, thus requiring a busy restaurant to utilize multiple units. For example, a typical sandwich restaurant of the “fast food” or “fast service” type may require six to eight steam cabinets in order to handle the demand at peak times. Food preparation personnel can easily lose track of which of two food servings within a given cabinet needs to be removed first and can lose track of which of the many steam cabinets a particular food serving was put into. It typically takes about four minutes to raise the food serving to the desired temperature. The units present burning hazards to the employees, both from the inherent high temperatures required to produce the steam and from the steam itself that escapes from the cabinets when the lids are opened.

In addition, where a sandwich restaurant desires to produce a consumable-at-sale sandwich having a toasted bun or other bread product in combination with a steam-heated filler of meat and/or cheese, problems arise in timing the heating steps, since it is most desirable to have the toasted bun ready at the same time the heated filler is ready. This is difficult to do since the toasting operation may involve a different time period. The problem may be further exaggerated where a conveyor toaster is employed, since matching the timing on the continuous toasting process and the batch steam heating process is hard.

It is an object of this invention to provide a steam cabinet that addresses these problems. It is an object to provide a steam cabinet that operates in a continuous manner rather than a batch manner. It is an object to provide such a steam cabinet that operates utilizing a conveyor system such that the food products are heated in order under a first-in-first-out operation. It is an object to provide such a steam cabinet that eliminates the need for excessive monitoring by the food preparation personnel. It is an object to provide such a steam cabinet that reduces the likelihood of injury to the food preparation personnel. It is an object to provide such a steam cabinet that provides a consistent processing time for each food product. It is an object to provide such a steam cabinet that reduces the processing time for each food product. It is an object to provide such a steam cabinet that enables a steam heated filler to be produced in a continuous heating method so as to complement production of a toasted bun or other bread product, whereby a sandwich having a toasted bun and steam heated filler is efficiently produced in a “fast food” or “fast service” type restaurant.

### SUMMARY OF THE INVENTION

The invention is a pass-through steam cabinet apparatus for heating food products, such as meat and/or cheese, using moist heat. The steam cabinet is able to process multiple food products in a continuous manner, such that individual food products pass successively through the steam cabinet in a first-in-first-out processing path by utilizing a conveyor means. The processing time and the processing temperature are variable and controllable. In addition, the invention comprises a method for producing or preparing a consumable-at-sale sandwich having a toasted bun or bread product with a steam or moist heated filler of meat and/or cheese, the method comprising toasting the bun and steam heating the filler in a continuous rather than a batch manner.

The steam cabinet apparatus comprises steam producing means and steam distribution means such that steam is directed, delivered or produced in a steam chamber through which the food products are passed in linear, continuous fashion by conveyor means. The conveyor means preferably includes a feed chute for receiving each food product at the start of the process, a conveyor belt to transport the food product through the steam chamber and a discharge chute to receive the food product after it has been heated.

A hood member, preferably hinged or otherwise removable to allow access to the interior of the processing area for cleaning or other purposes, defines a central steam chamber as well as a pair of venting chambers. The chambers are disposed such that the food product passes first through one of the venting chambers, then through the steam chamber, then through the other venting chamber. Moist heating of the food product primarily occurs in the central steam chamber. Hinged divider curtains are provided between the steam chamber and the venting chambers to retain the steam within the steam chamber, the divider curtains pivoting upon contact with metal trays containing the food products to allow passage of the trays through the apparatus. The venting chambers are provided with exhaust means to withdraw steam that escapes from the steam chamber, such that the excess steam can be vented externally rather than passing into the interior of the restaurant.

In one embodiment of the invention, the steam producing means of the steam chamber is a boiler and the steam distribution means are conduits or a manifold with opening in the steam chamber. In an alternative version of the invention, the steam producing means of the steam chamber apparatus comprises a heated plate or surface disposed beneath at least the upper surface of the conveyor belt and water dispersion means to spray or deposit water onto the heated surface to be directly converted into steam. Dispersion of the water onto the heated surface may be continuous or intermittent.

The apparatus enables a fast food sandwich restaurant worker to prepare a sandwich by toasting a bun or roll on a conveyor toasting apparatus and simultaneously steam heating the meat and/or cheese on the continuous process steam heating apparatus, such that the meat and cheese can be placed into the hot toasted bun immediately upon discharge from the steam heating apparatus.

### BRIEF DESCRIPTION OF THE DRAWINGS

FIG. 1 is a front view of the invention, shown partially exposed and in cross-section.

FIG. 2 is an end view of the invention with the hood in the closed position.

FIG. 3 is an end view of the invention with the hood in the open position showing the steam distribution means and the exhaust means.

FIG. 4 is a partial view of the conveyor means and an alternative steam producing means.

### DETAILED DESCRIPTION OF THE INVENTION

The invention is a steam cabinet apparatus that heats food products using moist heat in a continuous pass-through manner rather than in a batch manner, such that food products are processed on a first-in-first-out basis. The invention further comprises a methodology of preparing a sandwich wherein the bread is toasted on a conveyor toasting apparatus and the meat and/or cheese is steam heated in a conveyor steam cabinet as described herein, such that a consumable-at-sale sandwich having a toasted bun and steam heated filler can be efficiently prepared in a “fast food” or “fast service” style restaurant.

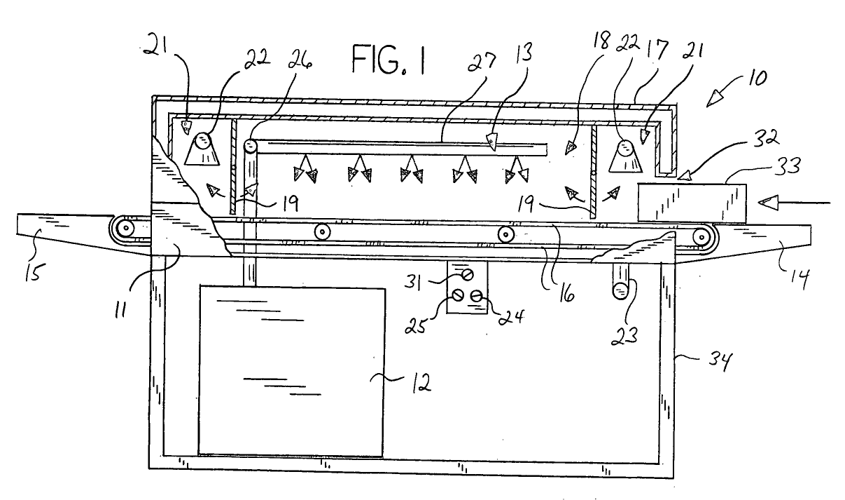

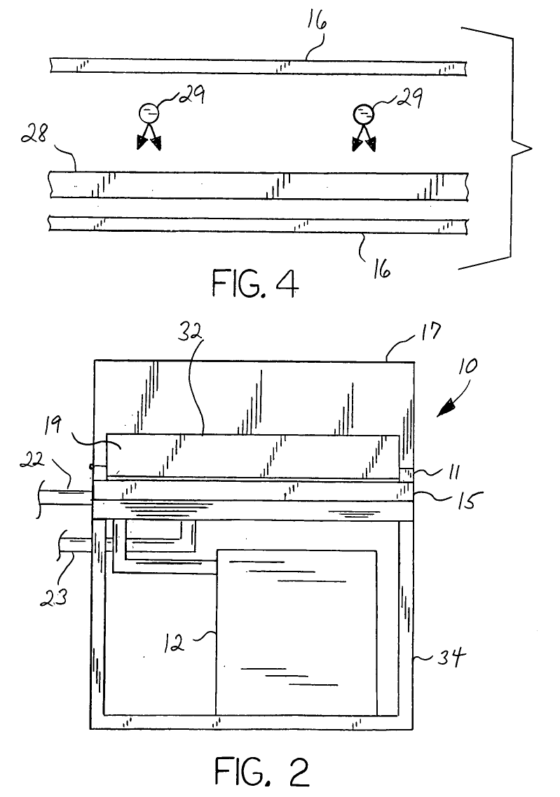

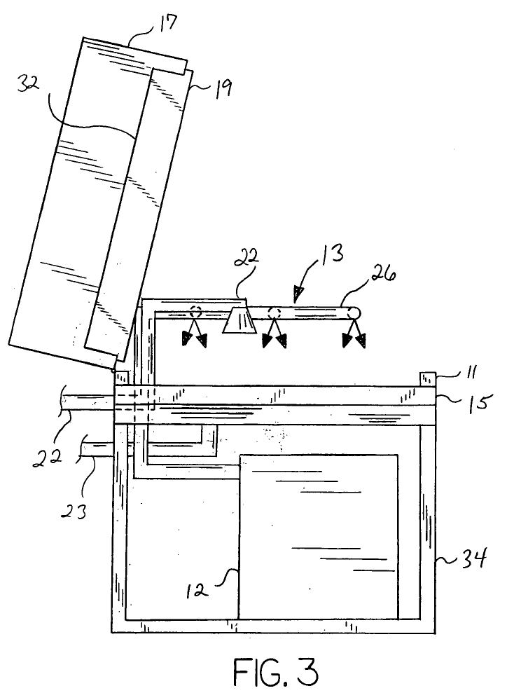

In a first embodiment of the apparatus for steam heating a food product for processing or preparation for consumption-at-sale, as shown in FIGS. 1 through 3, the steam heating apparatus comprises a steam cabinet 10 mounted on a base, legs or stand 34, steam producing means 12, and steam distribution means 13 to deliver the steam into a steam chamber 18 disposed within steam cabinet 10. The steam cabinet 10 is a hollow body that is designed to retain sufficient moist heat to process the food product as it passes therethrough, and preferably is insulated or double-walled such that the outer surfaces of the steam cabinet 10 remain significantly cooler than the interior. The steam cabinet 10 comprises the combination of a steam chamber 18 bounded on either side with a venting chamber 21, all of which are defined by the combination of an insulated hood member 17, preferably hinged or removable such that the interior of the steam cabinet 10 is accessible for cleaning or repair as required, and a bottom member 11.

The venting chambers 21 are of lesser volume than the central steam chamber 18 and much shorter in the lateral end-to-end or travel direction. Hinged or otherwise movable divider members or curtains 19 are provided to separate the steam chamber 18 from the venting chambers 21, such that steam is retained within the steam chamber 18, the divider curtains 19 being temporarily pivoted by passage of trays 33 bearing the food product as the food product trays 33 pass through the steam cabinet 10. Exterior openings 32 are disposed on the outer sides of the venting chambers 21 and steam cabinet 10 such that the food product trays 33 pass into and out of the steam cabinet 10 in an unimpeded manner. The trays 33 are most preferably apertured or constructed of a wire mesh such that the steam heat can easily reach the food product.

A powered conveyor means 16, having a metal mesh belt or the like, is disposed so as to pass items through the first opening 32 into and through a first venting chamber 21, then through the steam chamber 18 and then through and out of the second venting chamber 21 through the second opening 32. A feed chute or platform 14 and a discharge chute or platform 15 is provided on either side of the conveyor means 16, such that the operator places a metal tray 33 containing a food product onto the feed chute 14 and slides it onto the conveyor means 16 a distance sufficient for the tray 33 to be grabbed by the conveyor means 16. The tray pivots the divider curtains 19 as it passes into and from the steam chamber 18, such that release of steam from the steam chamber 18 and variations in the interior temperature are minimized. The conveyor means 16 preferably may be run in either direction.

An exhaust means 22 is provided in each venting chamber 21 to remove any excess steam before it enters the restaurant, the excess steam preferably being vented externally from the interior of the restaurant. Drain means 23 are provided in the bottom member 11 of the steam cabinet 10 to remove any condensation. The apparatus is provided with speed control means 24 to control the speed of the conveyor means 16 and temperature control means 25 to control the temperature in the steam producing means 12 and within the steam chamber 18. The steam producing means 12 may be designed to continuously produce steam or to produce steam intermittently or upon demand.

In an alternative embodiment, illustrated in FIG. 4, the steam producing means 12 comprises a heated plate or surface 28 mounted beneath at least the upper surface of the belt comprising the conveyor means 16, and water dispersion means 29 capable of dispersing water onto the upper surface of the heated plate 28. Water dispersion means 29 may comprise multiple nozzles or the like connected to water conduits and a pumping or spraying means, such that a suitable amount of water is dispersed onto the heated plate 28 to produce the required amount of steam. The water dispersion means 29 is controlled by water dispersion timing means 31, preferably such that water dispersal occurs intermittently during operation of the apparatus, such as every 15 seconds for example, although continuous steam production or production on demand is also possible.

It has been determined that a temperature of approximately 140 degrees F. is the optimal temperature to heat a food product comprising a combination of slices of meat and cheese based on an initial refrigeration temperature of 60 degrees F. or less. For a steam cabinet 10 with a steam chamber 18 approximately 55 inches in length, 26 inches in width and 6 inches in height, a processing time (time the food product resides in the steam cabinet 10) of approximately 2 minutes is desirable. This time period corresponds favorably to the amount of time the food personnel require to simultaneously toast a bun or roll on a standard conveyor toasting apparatus and prepare the condiments, such that preparation time for a sandwich having a toasted bun and steamed meat/cheese filler combination is reduced from known practice since the heated meat/cheese filler combination can be placed onto the simultaneously toasted bun immediately upon discharge from the continuous pass-through steam cabinet 10.

The method of preparing a sandwich comprising a bread product and a filler composed of meat, cheese or meat and cheese comprises the steps of heating said filler in a continuous, pass-through the steam heating apparatus having conveyor means 16 to move the filler through a steam chamber 18 to heat the filler with moist heat; simultaneously toasting the bread product in a continuous, pass-through toaster apparatus having conveyor means to move the bread product therethrough; and combining the steam heated filler and the toasted bread. The method further comprises providing the steam heating apparatus with a steam chamber 18 between two venting chambers 21; and removing from the venting chambers 21 any steam that escapes from the steam chamber 18. Even further, the method comprises the steps of providing a tray member 33 to receive the filler for transport on the conveyor means 16; providing pivotable divider members 19 between the venting chambers 21 and said steam chamber 18; and pivoting the divider members 19 by contacting the divider members 19 with the tray member 33.

It is understood that equivalents or substitutions for certain elements set forth above may be obvious to those skilled in the art, and therefore the true scope and definition of the invention is to be as set forth in the following claims.

We claim:

1. A steam heating apparatus, the apparatus heating a food product for consumption-at-sale in a pass-through manner, said apparatus comprising:
steam producing means such that moist heat is brought into contact with a food product;
a steam cabinet comprising a steam chamber for exposing said food product to moist heat, said steam cabinet disposed between two venting chambers containing exhaust means, whereby steam entering said venting chambers from said steam chamber is removed from said venting chambers; and
conveyor means such that said food product is brought through said steam chamber and said venting chambers.

2. The apparatus of claim 1, further comprising movable divider members disposed between said steam chamber and said venting chambers.

3. The apparatus of claim 2, wherein said divider members are pivotable.

4. The apparatus of claim 1, wherein said steam cabinet comprises a hood member and a bottom member.

5. The apparatus of claim 4, wherein said hood member is hingedly joined to said bottom member.

6. The apparatus of claim 4, wherein said hood member is removably disposed on said bottom member.

7. The apparatus of claim 1, further comprising exterior openings disposed in said venting chambers.

8. The apparatus of claim 1, wherein said steam producing means comprises a boiler.

9. The apparatus of claim 8, further comprising steam distribution means for delivering steam from said steam producing means to said steam chamber.

10. The apparatus of claim 9, wherein said steam distribution means comprises a steam header and steam pipes disposed within said steam chamber.

11. The apparatus of claim 1, wherein said steam producing means comprises a heated surface and water dispersion means for distributing water to said heated surface.

12. The apparatus of claim 1, further comprising speed control means to control the speed of said conveyor means and temperature control means to control the temperature within said steam chamber.

13. The apparatus of claim 3, further comprising a tray member to receive said food product, whereby said tray member is moved by said conveyor means and pivots said divider members upon contact.

14. A steam heating apparatus, the apparatus heating a food product for consumption-at-sale in a pass-through manner, said apparatus comprising:
steam producing means such that moist heat is brought into contact with a food product;
a steam cabinet comprising a steam chamber for exposing said food product to moist heat, said steam cabinet disposed between two venting chambers containing exhaust means, whereby steam entering said venting chambers from said steam chamber is removed from said venting chambers;
pivotable divider members disposed between said steam chamber and said venting chambers to minimize passage of steam from said steam chamber to said venting chambers; and
conveyor means such that said food product is brought through one of said venting chambers, then through said steam chamber and then through the other of said venting chambers.

15. The apparatus of claim 14, wherein said steam cabinet comprises a hood member and a bottom member.

16. The apparatus of claim 15, wherein said hood member is hingedly joined to said bottom member.

17. The apparatus of claim 15, wherein said hood member is removably disposed on said bottom member.

18. The apparatus of claim 14, further comprising exterior openings disposed in said venting chambers.

19. The apparatus of claim 14, wherein said steam producing means comprises a boiler.

20. The apparatus of claim 19, further comprising steam distribution means for delivering steam from said steam producing means to said steam chamber.

21. The apparatus of claim 20, wherein said steam distribution means comprises a steam header and steam pipes disposed within said steam chamber.

22. The apparatus of claim 14, wherein said steam producing means comprises a heated surface and water dispersion means for distributing water to said heated surface.

23. The apparatus of claim 14, further comprising speed control means to control the speed of said conveyor means and temperature control means to control the temperature within said steam chamber.

24. The apparatus of claim 14, further comprising a tray member to receive said food product, whereby said tray member is moved by said conveyor means and pivots said divider members upon contact.

25. A method of preparing a sandwich comprising a bread product and a filler composed of meat, cheese or meat and cheese, the method comprising the steps of:
heating said filler in a continuous, pass-through steam heating apparatus having conveyor means to move said filler through a steam chamber to heat said filler with moist heat;
simultaneously toasting said bread product in a continuous, pass-through toaster apparatus having conveyor means to move said bread product therethrough; and
combining said steam heated filler and said toasted bread.

26. The method of claim 25, further comprising the steps of:
providing said steam heating apparatus with a steam chamber between two venting chambers; and
removing from said venting chambers any steam that escapes from said steam chamber.

27. The method of claim 25, further comprising the steps of:
providing a tray member to receive said filler for transport on said conveyor means;
providing pivotable divider members between said venting chambers and said steam chamber; and
pivoting said divider members by contacting said divider members with said tray member.
